(19) United States
(12) Patent Application Publication
(10) Pub. No.: US 2007/0027911 A1
(43) Pub. Date: Feb. 1, 2007

(54) Method and arrangement for naming pictures to be saved in a mobile station

(76) Inventors: Tero Hakala, Kangasala (FI); Juha Lehikoinen, Lakiala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/570,646

(22) PCT Filed: Aug. 30, 2004
(86) PCT No.: PCT/FI04/50121

§ 371 Date: Mar. 3, 2006

(30) Foreign Application Priority Data
Sep. 4, 2003 (FI) 20035143

(51) Int. Cl. G06F 7/00

(52) U.S. Cl. 707/104.1

(57) ABSTRACT

The invention relates to recording pictures, produced by a mobile station, in the mobile station and to naming the recordable picture files. In order to name the picture files, among the data available in the mobile station, there is searched a given feature associated to the picture, and the searched feature is added in the name suggestion list containing picture file name suggestions in order to create said name suggestion list. The created name suggestion list is displayed in the user interface, where the picture file name can be edited.

The invention relates to the recording of pictures pictured by a mobile station in said mobile station, and particularly to the naming of picture files individually.

The quantity of pictures saved in a mobile station increases continuously, because more and more mobile stations are provided with a camera. The cameras can be fixed, integrated elements of the mobile station, or auxiliary accessories to be installed in the mobile station. In addition, the quality of the cameras is continuously improved, at the same time as their size is reduced, which means that cameras and pictures become more and more common in mobile stations. Pictures can be taken at shorter and shorter intervals, even as short continuous cycles of successive pictures, which further increases the amount of pictures to be saved. When the amount of pictures taken by mobile stations and pictures to be saved in mobile stations increases, picture management becomes more and more important.

The finding of a certain picture from among a large amount of pictures takes time and is cumbersome. Typically the picture files saved in the memory of a mobile station are named so that the file name includes a possible initial part expressing that the file in question is a picture file, a successive consecutive number and a qualifier according to the picture format. The pictures can be named for instance so that at the beginning of each picture name, there is added the character string “image”, and after this character string there is added the number indicated by the calculator and a qualifier, for example “.jpg”. In some devices, the user may define the character string that constitutes the first part of the picture file name, so that the files are immediately identified as picture files. However, the first part is the same for all picture files to be saved, and the file names are distinguished only by said value indicated by the calculator. One of the problems of file names identified by calculator values is that generally the length of the file names has a maximum value. When this maximum length is achieved by the highest possible calculator value, for instance when the maximum length of the file name is 6 characters and the latest name is “image9.jpg”, the calculator is reset, and both the calculator and the file numbers start running over from the beginning. If the picture file called “image0.jpg” that was created earlier still is saved in the mobile station when the calculator is reset, the new file “image0.jpg” is written over the earlier one, and the data saved in the earlier file is lost.

Another problem when using file names distinguished by calculator values is the fact that the files are difficult to manage. Typically all picture files are saved in the same location, and they are mutually distinguished only by consecutive numbers. When searching for a certain picture file, generally the only alternative is to go through the picture files until the desired file is found. The loading of the pictures on the display takes time, which means that the going through of picture files is generally very slow and frustrating work. In the display browser, the picture files are typically displayed in the same order in which they were saved, i.e. in the numerical order, and without opening the files, it is impossible to obtain any information of pictures that are possibly mutually associateed or of certain pictures that are being searched. When the number of pictures to be processed is several hundreds, the management and processing of prior art picture files becomes impossible.

In most cases, picture files are searched on the basis of their names. Often the file name is the only text-form description of the picture contained in the file, apart from picture files with meta data embedded therein. Thus it is important to give names to the picture files. The larger is the number of picture files to be processed, the more significant are the file names in regard to the processing, searching and finding certain pictures, and in general with respect to all forms of picture management and use.

The objective of the invention is to produce a method and arrangement for making the processing of mobile station picture files easier, faster and simpler. Another objective of the invention is to individualize the picture files, so that their names can be clearly distinguished between each other. Yet another objective is to give descriptive names to mobile station picture files. Yet another objective of the invention is to name mobile station picture files simply and easily.

The objectives are achieved so that by means of data existing or available in the mobile station, there are produced name suggestions for the picture file, whereafter the name suggestions are compiled in a name suggestion list and the list is displayed in the user interface, where the picture file name can be edited.

The invention is characterized by what is set forth in the independent claims. Other embodiments of the invention are described in the dependent claims.

According to an embodiment for naming a mobile station picture file, in which picture file there is saved a picture produced by the mobile station camera, among the data available in the mobile station, there is looked up a given feature associated with the picture, said feature is added as a name suggestion in the name suggestion list containing name suggestions for the picture file in order to create said name suggestion list, and the created name suggestion list is displayed in the user interface, where the picture file name can be edited. The picture taken by the mobile station camera is in the mobile station saved in a picture file, and for naming said picture file, there is surveyed the data already existing in the mobile station; among the possible name suggestions, priority is given, according to given priority rules, to the best name suggestion to be suggested for the user and to be adopted as the default name for the picture file in question. According to an embodiment of the invention, the name suggestion list created on the basis of searched and found name suggestions is displayed to the user in the user interface, where the picture file name suggestion can be edited. According to an embodiment, in the user interface, where the picture file name can be edited, the picture file name is selected among the displayed name suggestions by pointing a given suggestion or several suggestions. According to another embodiment, in the user interface where the picture file name can be edited, the picture file name is created by editing the picture file name suggestion. The user of the user interface can edit the suggested file name, select the desired file name among the given suggestions, compile the file name to consist of several suggestions, or edit the suggestions. The method of naming pictures taken by a mobile station according to this embodiment is easy for the user, because in the method for naming picture files, there are utilized data and texts that already exist in the mobile station, and the user need not recreate them manually. By means of the menu, the user may only choose the desired option by pointing the selected item, and there is no need to rewrite for instance text that was already written once.

The invention can be applied in all available mobile stations. The invention essentially enhances picture processing, such as recording, searching, looking up, listing, organizing in indices or archives etc., because the file names given according to embodiments of the invention typically describe the contents of the picture in question. Apart from individualizing the files, descriptive file names also enable the identification and finding of given pictures without opening the files. In addition, the arrangement according to the invention enables the processing of picture files in the mobile station and also makes the processing easier, and it is not necessary to transfer the pictures to another device, such as a microprocessor, in order to process the picture files. As for mobile stations, the arrangement according to the invention brings added value, new features and functions. In addition, the arrangement according to the invention can easily be extended to future communication devices that record video image. Likewise, along with the development of image recognition algorithms and devices, s according to the invention there are obtained improved name suggestions due to the picture produced by the camera, and they describe the picture content better.

Advantageous embodiments of the invention are described in more detail below with reference to the appended drawings, where

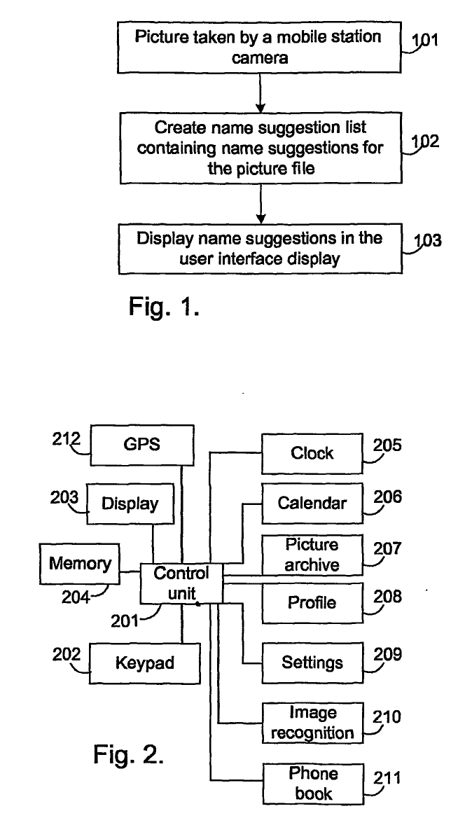

FIG. 1 illustrates a method according to an embodiment of the invention for naming picture files,

FIG. 2 is a block diagram illustrating a mobile station according to an embodiment of the invention, and

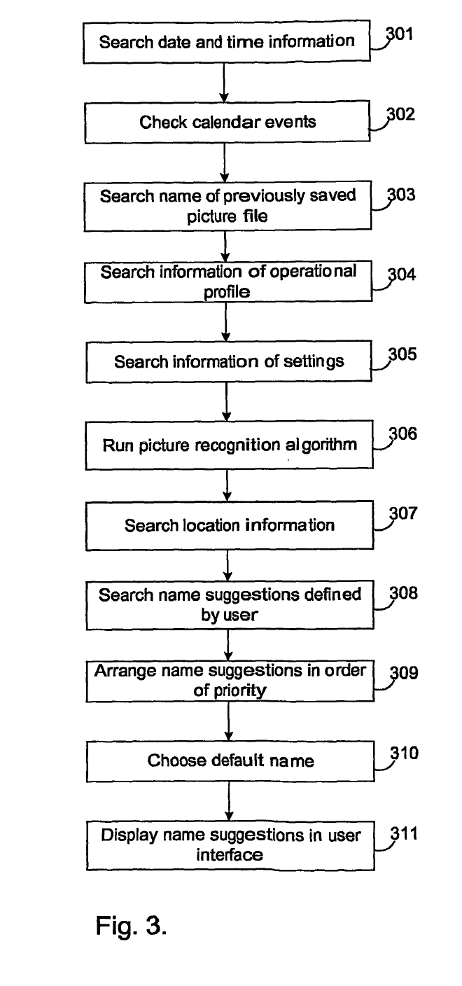

FIG. 3 illustrates a method according to an embodiment of the invention for creating name suggestions.

In FIG. 1, step 101, a picture is taken by the mobile station camera. Generally the picture is in digital form, and the camera required for taking said picture is integrated as a stationary element of the mobile station. The camera can also be connected as an auxiliary device in the mobile station, in which case embodiments of the invention can also be realized in existing mobile stations that originally were not provided with cameras. Here a picture may also mean a so-called video clip containing a series of successive pictures or recorded moving image. Also moving image recorded by a video camera, both by one integrated in the mobile station and an auxiliary device, can be saved and named according to an embodiment of the invention. In this application, all applicable picture forms are called pictures.

A picture taken by a mobile station is typically saved in the memory of the mobile station. In step 102 of FIG. 1, there is created a name suggestion list containing picture file name suggestions according to an embodiment of the invention on the basis of such data already existing in the mobile station that according to certain criteria is associateed with the picture taken in step 101. The name suggestion list is compiled so that in a given section or element of the mobile station, there is searched and found or produced a piece of information that was already written or saved in the memory of the device or otherwise already exists in the device. Applicable produced information is saved in the memory and added in the name suggestion list containing picture file name suggestions. Thus the name suggestion list is compiled of data already existing or available in the mobile station, and the name suggestions can be associateed for instance to the picture, its content, data contained therein, time or place or event of shooting, and so on. By means of the name suggestions given in the name suggestion list and created on the basis of features looked up in the mobile station, it is possible, in an easy and user-friendly way, to select a descriptive name for the picture file to be saved, which name is associateed to the picture contained in the picture file.

The created name suggestion list is displayed to the user in a user interface according to an embodiment in step 103. From the name suggestion list created according to an embodiment, there is chosen, according to certain priority rules, the name suggestion that is best associateed to the picture in question as the default name for the picture file. If for instance the name suggestion list includes a word that describes the contents of a picture, it can be set as the picture file default name that is suggested as the picture file name in the user interface in step 103. The chosen picture file default name is a suggestion that the user can easily accept. According to an embodiment, the user may also edit the suggested default name, for instance by changing it or by adding something thereto. Said editing operations can also be realized in a user interface according to an embodiment, by selecting from the generated name suggestion list a new name suggestion that replaces the earlier suggestion or is combined thereto. For example, the name suggestion list may include the time of the shooting, and from said time, at the end of the suggested default name for the picture file, there can be added the date or a verbal feature edited as a name suggestion on the basis of the time, such as summer, fall, evening, morning and so on.

According to an embodiment of the invention, a name suggestion list generated on the basis of the information already existing in the mobile station makes the naming of picture files easier and automatic. When the processing and saving of pictures is made easier, the mobile station is used more for image processing, and there is no need to first transfer the pictures to other devices in order to be able to manage them. Users get more functions and features in their devices, which again makes the mobile stations more versatile and meaningful to use.

The arrangement according to this embodiment for naming a picture file that records a picture taken by a mobile station camera comprises means for looking up a given feature associateed to the picture among the information available in the mobile station, means for generating a name suggestion according to said feature that was looked up, means for adding the generated name suggestion in the picture file name suggestion list and thus for creating said name suggestion list, means for displaying the created name suggestion list in the user interface and means for editing the picture file in the user interface. According to an embodiment, the arrangement also comprises means for arranging the information that was looked up in the mobile station in order to create a name suggestion for the picture file in a priority order according to certain priority rules, means for arranging the name suggestions so that the one with the highest priority is first in the name suggestion list, and means for setting the first name suggestion from the list as the default name for the picture file.

FIG. 2 is a block diagram illustrating essential elements of an embodiment of the invention; the illustration does not include for instance transmission and reception branches for establishing a network connection, for transmitting data into a network and for receiving data from a network, which elements do not have an essential effect in the invention, although they are essentially important for the mobile station itself. In the embodiment of FIG. 2, the control unit 201 takes care of the operation of the device and of controlling the operations. The control unit 201 comprises a microprocessor, by means of which the device operations are checked, controlled and observed. The control unit 201 is connected to all other functional sections and components of the device either directly or through their individual control units. An arrangement according to an embodiment includes means for feeding the picture file name suggestion, for looking up the fed picture file name suggestion in the mobile station, for editing the picture file name in the user interface and for choosing the picture file name from the name suggestion list created in the user interface by pointing out a given name suggestion or several name suggestions. The data input device illustrated in FIG. 2 is a keypad 202. Naturally the input device can also or alternatively be for example a touch display, a display requiring pencil input, a section receiving sound input, a mouse or any other corresponding device for feeding data in the device. The data of FIG. 2 is displayed in the display unit 203 in a user interface according to an embodiment. In addition, the device includes a memory unit 204 for storing data.

FIG. 2 illustrates, by way of example, such sections of the device that can be looked through In order to create a name suggestion list according to the invention. According to an embodiment, all devices among the means mentioned in connection with the embodiment 2 can be software means. The functions described in embodiments can be realized by means of existing sections and components, so that they are programmed to function according to embodiments of the invention. According to an embodiment, the arrangement comprises means for finding the mobile station date and time Information associated to the moment of shooting, for generating name suggestions of the found information, and for adding a name suggestion in the picture file name suggestion list. In the exemplary embodiment illustrated in FIG. 2, there is represented a clock 205 in which the time information of the moment of shooting is looked up. Typically the time information comprises a time and a date, which can be processed into numerical name suggestions or verbal name suggestions for instance on the basis of the found name of the month, time of day or the season.

According to an embodiment, the arrangement comprises means for looking up or searching from the mobile station a calendar event associated at a given accuracy to the moment of shooting, and for adding the possibly found calendar event as a name suggestion in the picture file name suggestion list. In FIG. 2, there is illustrated a calendar 206 that can contain notes and reminders essentially associated to a given time that can at a given accuracy be compared with the moment of shooting. Typically the user feeds data in the calendar through the keypad 202. The data associated to the calendar 206 can be saved in the memory unit of the device, in a part of the memory that is allocated for the calendar, or in a separate memory unit 206 of the calendar, which is not illustrated in FIG. 2. The arrangement also includes means for comparing the time information of the shooting moment or the time information brought in the list from the clock with the time information of the found calendar event.

According to an embodiment, the arrangement also comprises means for looking up the previously saved picture file name in the mobile station and for adding it as a name suggestion in the picture file name suggestion list. The picture archive of block 207 illustrates that memory unit or that part of a memory unit where the picture files of the device are saved. The arrangement also includes a user interface for processing the picture archive. In addition, the arrangement comprises means for comparing the file recording times in order to find the name of the previous picture file from the picture archive.

According to an embodiment, the arrangement also comprises means for searching data from the operation profile 208 and from settings 209, as well as means for creating a name suggestion on the basis of found information, as well as means for adding the name suggestion in the picture file name suggestion list. The profile 208 means a file that includes user-specific information for defining a user-specific operation environment. The definitions of the profile 208 are related to sound choices and their volumes, for instance. As for the settings 209, they comprise general call settings, language and network selection as well as a possible greeting text that is displayed on the screen 203 when the device is switched on. Among these, there can be looked up a given, predetermined piece of information, or information associated to the picture on given grounds, which information is then used for creating a name suggestion to be added in the picture file name suggestion list.

In the embodiment of FIG. 2, there also is illustrated the image recognition block 210. According to an embodiment of the invention, the arrangement comprises image recognition means 210 for processing the picture to be saved and for finding in the picture the features that should be recognized, as well as means for generating a name suggestion according to the features recognized in the picture. The picture available in the device can be processed by the means and algorithms provided in the image recognition block 210 in order to find in the picture such targets or elements that should be recognized. By means of the image recognition technique, there is obtained information as for the contents of the picture to be named, and from these targets associated to the picture contents, there are obtained extremely good and descriptive file name suggestions to be added in the name suggestion list compiled according to the invention. By using the image recognition means illustrated in block 210, in the picture that is taken, there is searched a familiar or known pattern or target for instance according to a pattern recognition algorithm. For example a familiar place can be recognized in the picture. On the basis of the recognized targets, the picture can for instance be further classified in a group of earlier pictures, whereafter the picture file name suggestion to be added in the name suggestion list can be a group-specific name suggestion or the first part of it.

FIG. 2 illustrates a phone book 211; the data contained in said phone book can also be utilized when creating name suggestions according to embodiments of the invention. From the point of view of the invention, a feasible name suggestion can be generated for example of the state data saved in a dynamic phone book 211. The user can record in the dynamic phone book 211 a piece of state information, for instance “I am at a meeting”. In addition, the user may grant given other users permission to request this piece of state information. The state information may include data both in text and image form. According to an embodiment of the invention, the image data of the state information can be further processed by image recognition technique in order to generate name suggestions.

The embodiment of FIG. 2 includes means for enquiring the location data of the mobile station and for creating a picture file name suggestion on the basis of the received location data. For positioning, FIG. 2 includes a GPS (global positioning system) block 212, through which the mobile station can receive location data produced by the global positioning technique, which data typically comprises the current position coordinates of the mobile station. In addition, the mobile station is provided with means for processing the received location data. For example, there can be available a map application, by means of which the location coordinates can be transformed into address data or other verbal location data on the basis of the received location coordinates.

FIG. 3 illustrates a method according to an embodiment of the invention for creating a name suggestion list. In step 301, in the mobile station there is looked up the date and time information that is associated to the moment of shooting, said data is turned into a name suggestion, and said name suggestion is added in the picture file name suggestion list. In the mobile station, there is looked up the date and time information relating to the moment of shooting, and on the basis of these, numerical name suggestions, such as date and time, or verbal name suggestions, such as morning, night, summer, winter, can be generated in the name suggestion list.

According to an embodiment, in the mobile station there is looked up a calendar event that is at a given accuracy associated to the moment of shooting, and in case a suitable calendar event is found, said calendar event is added as a name suggestion in the picture file name suggestion list. In step 302, the calendar events are surveyed, and their suitability as name suggestions for picture files is studied, for instance by comparing their point of time with the device's shooting time information found in step 301. In case there are found calendar events or notices associated to the same point of time, at a given accuracy, they are added in the name suggestion list. The calendar may include a notice for instance of an event or anniversary, such as football training, an outdoors concert or a birthday party, which are generally good and descriptive suggestions to the name suggestion list.

In step 303, in the mobile station there is looked up the file name of the previously saved picture file, and it is added as a name suggestion in the name suggestion list of the picture file to be saved. The previously saved picture file is looked up in the picture file archive or a corresponding location, where the pictures are saved. In this step it is also possible to search other information associated to the previously saved picture, particularly if only a short period of time has lapsed after recording the previous picture file. If the period between the two last pictures is shorter than a given limit, the new name suggestion can have the same first part as the previous picture. However, there must be a distinguishing feature between the file names in order to be able to identify them as separate files. According to an embodiment it can be defined that the default name set for two successive pictures taken within a short period of time can be one and the same name suggestion. Then the file names can be somehow distinguished, for instance by means of a name suggestion to be added at the end of the name. According to an embodiment, the feature used for distinguishing the picture files is the point of shooting time looked up in the device clock, because two separate pictures cannot have exactly identical shooting times.

In step 304, in the user-specific operational profile data of the device, there are looked up possible name suggestions for the picture file. In step 305, from the device settings and the current mode, there are looked up possible suggestions to the name suggestion list According to an advantageous embodiment, from the mobile station profile and settings, there is looked up information that is associated to the picture on certain grounds, such as the name of the chosen ringing tone, the name of the logo, the welcome note, the name of the user profile or another existing piece of information, which is then added as a name suggestion in the picture file name suggestion list. According to an embodiment, from the dynamic phone book of the mobile station, there is looked up the state information set by the user, and said state information is set as a name suggestion for the picture file. The state information is the current state information set by the user, which is typically a piece of information that can be looked up by certain persons defined by the user. The state information can for example express that the user is abroad, in which case the person who looked up the information in the mobile station may for instance arrange to contact the user at a more suitable moment, or at least he is aware of the possible time difference between his place of stay and that of the user who is abroad. The state information may contain text that can be used as a name suggestion as such or after editing. In addition, the state information may contain picture information which can be edited into a name suggestion for example by means of image recognition technique.

According to an embodiment, the picture to be saved is processed by a mobile station image recognition algorithm in order to generate picture file name suggestions on the basis of features recognized in the picture, and the generated name suggestion is added in the picture file name suggestion list. In step 306, the image recognition algorithm is run, and certain features are looked up in the picture to be saved. By means of image recognition technique, it is possible to observe for instance the brightness of the picture, the patterns, persons, targets, places, environments etc. presented in the picture. From these, there can be generated name suggestions, or they can be for instance compared with the corresponding feature of the previous picture, and the name suggestion can be generated on the basis of this comparison, so that the common features are added in the name suggestion list. By using image recognition technique, the pictures can also be arranged in groups already at the recording step, so that the name suggestions generated on the basis of given features—which features and suggestions were already represented in an earlier picture or picture group—are priorized to be the most important and are placed highest in the name suggestion list, so that in the generated name suggestion list, the name suggestions are in an order of importance, and the one that is priorized as the best is first in the list. For instance when generating name suggestions, on the basis of the brightness of the picture it can be assumed that the time of shooting is night. In case said point of time is night also according to the mobile station clock, said two hints obtained from two different locations support each other, so that said hint constitutes a reliable indication of the shooting time. According to an embodiment, the created strong hint is added as a name suggestion, typically at the top end of the name suggestion list.

The name suggestion lists of pictures that contain same features likewise contain same name suggestions and even in the same order, in case the same priority rules have been applied. The pictures can be grouped on the basis of the default names suggested for the picture files, so that the default names of picture files that resemble each other and contain same features include the same name suggestions found in image recognition.

In step 307, there is looked up the current location information of the mobile station, which information is produced for example by means of the GPS positioning technique. The coordinate information obtained from GPS positioning can, for example by means of a map application used in the Internet, be transformed for instance into verbal address data or to a place, building, land or town recognized on the basis of the location coordinates. Of these, a name suggestion according to an embodiment of the invention can be created. Some well-known targets, for instance the Statue of Liberty, can be recognized both in the picture by using an image recognition algorithm, as well as on the basis of the produced location data of the mobile station.

According to an embodiment, in the mobile station there is looked up a name suggestion defined by the user, and the found name suggestion defined by the user is set as a name suggestion in the picture file name suggestion list. In step 308, there are looked up in the memory the name suggestions fed in by the user. The user may feed and record the most generally used names in his device. These are always included in the name suggestion list to be created. In the embodiment of FIG. 3, these are printed separately and last, but naturally the user's own name suggestions can be added for instance as a part of a user-specific profile, in which case corresponding information in this embodiment would be looked up in step 304. In connection with the description of FIG. 3, there are given examples of the information to be compiled in the name suggestion list. Obviously the name suggestion list can be compiled further or in a way different from the above description, by means of any piece of information already existing or available for the device, or by means of information produced on the basis of the picture.

According to an embodiment, the name suggestions in the generated picture file name suggestion list are priorized according to certain predetermined priority rules, the name suggestions are set in order so that the one with the highest priority is placed highest in the list, and the first name suggestion in the name suggestion list is set as the default name for the picture file in the user interface. In the embodiment of FIG. 3, the generated name suggestions are priorized, i.e. set in an order of priority according to given priority rules in step 309. The priority rules can be defined In several ways that are applicable in any given situation. For instance it can be defined that the name suggestions are looked up in a given order of importance, so that they can be added in the name suggestion list in the same order as they will be looked up, and the separate priorizing step 309 is left out as unnecessary. Secondly, always when a new name suggestion is found, it can be compared with the ones already existing in the list, and a place for it can be found in the list. Typically the most important name suggestion that is classified as the most appropriate is placed first in the list. The suggestions can be arranged in an order or priority, so that the order is defined according to from where or in which step the name suggestions are looked up. According to another embodiment, the order is affected by which suggestions are identical with those of the previously saved picture. This is typically associated to a time limit, so that the information of the previous picture is valid for instance only if the date is the same, or for example so that when the previous picture becomes a week old, it does not anymore have significance when naming a new picture. According to an embodiment, it can be defined that a possibly found calendar event that suits the point of time always is the best hint. According to another embodiment, all hints are compared with name suggestions generated by image recognition, and the most appropriate among these is chosen according to the priority rules. Moreover, the priority rules may define that for example verbal hints always come before numeric hints, or that five-letter name suggestions are priorized on a higher level than for instance two- or eight-letter name suggestions. According to one priority rule, the name suggestions selected for the highest level are those that best resemble the searched input fed in by the user. The priority rules may define that in case two separate searches result in the same or nearly the same name suggestion, it is raised higher in the order of priority than where the name suggestion as such would qualify. Typically the default names favor names that contain a known word or term, because a verbal name always gives a hint or assumption as for the contents of the named file, which is essential when processing the files later.

After the name suggestions are priorized in step 309, from among them there is chosen the most suitable default name with the highest priority for the picture file in step 310. In this embodiment, the name that was classified as the best suggestion in step 309 is now set as the default name for the picture file. In step 311, the generated name suggestions are displayed to the user on the display of the user interface. On the basis of the displayed name suggestions, the user may replace the suggested default name with a completely different name, or he may edit the suggested name. The picture file name can be chosen among the found name suggestions by pointing one or several of them, or by editing the name. The name can be compiled to contain several parts, so that for instance after the default name “duck” generated on the basis of image recognition, there is added the season created on the basis of the date information by selecting it from the user interface menu, where the name suggestions are presented. Now the adopted name is for instance “duck-winter”, in which case the first part of the name describes the contents of the picture to be saved, and the last part associates the picture to the moment of shooting. From the created file name, there can also be drawn the conclusion that the saved picture represents a winter-coated duck bird. According to an embodiment, in between the parts of file name suggestions compiled of several parts, there is added a separator, such as the hyphen (-) used in the example above. After the file name, there is generally added a qualifier automatically in the user interface.

When the desired picture file name is chosen, the mobile station checks that a corresponding file name is not already saved in the mobile station. In case a completely identical file name is found, according to an embodiment the mobile station informs the user to that effect. In this connection, the user may be asked to change the name, if he does not wish to save the picture to be recorded in the file with the same name that was saved earlier, in which case the contents of the earlier picture file are lost. According to another embodiment, the mobile station adds in the name suggestion for instance a serial number, a time parameter or the name suggestion located next in the name suggestion list, by means of which the file name can be distinguished from the preceding name. Typically the picture to be saved is not written in the already existing picture file, but the user is informed of the situation, and there is possibly suggested a change in the picture file name chosen by the user in order to identify said file.

One embodiment of the invention can be immediately applied when the picture to be saved is taken by the mobile station camera. Thereafter there is, according to an embodiment, created a name suggestion list, and a file name is automatically suggested for the picture according to the name suggestion that has the highest priority. The name suggestion list is presented in a user interface according to an embodiment, and the user may pick the desired suggestion/suggestions or edit the name manually, for instance through the keypad. According to another embodiment, the name suggestion list according to the invention is created already before shooting the picture to be saved by the mobile station camera. The user may edit the picture file name to be created as he wishes, by using the name suggestions or without them. The name suggestion list is compiled on the basis of information that is available, such as the name suggestions defined by the user, the name of the previously saved picture file, the setting and profile data saved in the device. The created picture file name is typically used as a prefix for the pictures to be saved next. According to a third embodiment, there is named an earlier recorded picture file that is already saved in the memory of the mobile station. For the picture file saved in the memory, there is created a name suggestion list according to an embodiment of the invention. All data regarding the moment of shooting the picture file saved in the memory is not necessarily available anymore, but in this embodiment, it is possible to utilize the available information that can be produced or looked up by means of the existing picture file. For instance, a calendar note that is possibly simultaneous with the earlier moment of shooting already is probably unavailable, but the picture file can be processed by image recognition means, in which case feasible name suggestions for the name suggestion list to be created are generally obtained on the basis of the picture file contents. Also in this embodiment, name suggestions and means for changing the default names are offered for the user in the user interface display.

In the above specification, we have by way of example described various ways for generating name suggestions according to embodiments of the invention on the basis of the information available for a mobile station. The described embodiments and the examples contained therein do not, however, restrict the scope of the invention. Along with the development of devices and pictures, information that is useful for embodiments of the invention can be searched and produced in many different ways for instance on the basis of variable picture information with variable contents, such as a video recording.

1. A method for naming a mobile station picture file, in which picture file there is saved a picture produced by the camera of the mobile station, that the method comprising the following steps:
among the data available in the mobile station, there is searched a given feature associated to the picture,
of said found feature, there is created a name suggestion that is added in the name suggestion list containing name suggestions for the picture file in order to create said name suggestion list, and
the created name suggestion list is displayed in the user interface, where the picture file name is editable.

2. A method according to claim 1, wherein in the mobile station, there is searched the date and time information associated to the moment of shooting, a name suggestion is created on the basis of said information, and the name suggestion is added in the picture file name suggestion list.

3. A method according to claim 1, wherein in the mobile station, there is searched a calendar event that is at a given accuracy associated to the moment of shooting, and in case such a calendar event is found, said calendar event is added as a name suggestion in the picture file name suggestion list.

4. A method according to claim 1, wherein in the mobile station, there is searched the file name of the previously saved picture file, and it is added as a name suggestion in the picture file name suggestion list.

5. A method according to claim 1, wherein in the mobile station operational profile and settings, there is searched data associated to the picture according to certain criteria, and said data is used for creating a name suggestion in the picture file name suggestion list.

6. A method according to claim 1, wherein the picture to be saved is processed by an image recognition algorithm of the mobile station in order to produce a picture file name suggestion by means of the features recognized in the picture, and that the produced name suggestion is added in the picture file name suggestion list.

7. A method according to claim 1, wherein there is searched the location information of the mobile station, and on the basis of said location information, there is created a name suggestion to be added in the picture file name suggestion list.

8. A method according to claim 1, wherein in the mobile station, there is searched a name suggestion defined by the user, and said found name suggestion defined by the user is added in the picture file name suggestion list.

9. A method according to claim 1, wherein the name suggestions contained in the created picture file name suggestion list are arranged in an order of priority according to certain predetermined priority rules, so that the name suggestion with the highest priority is arranged first in the name suggestion list, and that the first name suggestion of the name suggestion list is set as the default name of the picture file in the user interface.

10. A method according to claim 1, wherein in the user interface the picture file name is editable, and the picture file name is chosen among the displayed name suggestions by pointing one or several of them.

11. A method according to claim 10, wherein in the user interface the picture file name is editable, and the picture file name is created by editing the picture file name suggestion.

12. A method according to claim 1, wherein the steps according to the method are performed in the mobile station before taking the picture, to be later saved, by the mobile station camera.

13. A method according to claim 1, wherein the steps according to the method are performed immediately after the picture to be saved is taken by the mobile station camera.

14. A method according to claim 1, wherein the steps according to the method are performed on the basis of a previously saved picture that is already stored in the memory of the mobile station and contained in a picture file.

15. An arrangement for naming a picture file containing a picture produced by a mobile station camera, said arrangement including
means for searching a given feature associated to the picture from a data available in the mobile station,
means for creating a name suggestion on the basis of said searched feature,
means for adding the created name suggestion in the name suggestion list of the picture file and hence means for creating said name suggestion list,
means for displaying the created name suggestion list in the user interface, and
means for editing the picture file name in the user interface.

16. An arrangement according to claim 15, including means for searching in the mobile station date and time information associated to the moment of shooting, in order to create a name suggestion of the found information and in order to add the name suggestion as a name suggestion in the name suggestion list of the picture file.

17. An arrangement according to claim 15, including means for searching in the mobile station a calendar event associated to the moment of shooting at a given accuracy, and means for setting the possibly found calendar event as a name suggestion in the picture file name suggestion list.

18. An arrangement according to claim 15, including means for searching in the mobile station the previously saved picture file name and for adding it as a name suggestion in the picture file name suggestion list.

19. An arrangement according to claim 15, including means for searching information in the mobile station operational profile and settings, and means for creating a name suggestion on the basis of the found information, and means for adding the created name suggestion in the picture file name suggestion list.

20. An arrangement according to claim 15, including image recognition means for processing the picture to be saved and for searching recognizable features in the picture, as well as means for creating a picture file name suggestion according to the features recognized in the picture.

21. An arrangement according to claim 15, including means for enquiring location information of the mobile station and means for creating a picture file name suggestion on the basis of received location information.

22. An arrangement according to claim 15, including means for feeding the picture file name suggestion, and means for searching from the mobile station the picture file name suggestion saved in the mobile station.

23. An arrangement according to claim 15, including means for arranging the picture file name suggestions created in the mobile station in an order of priority according to certain predetermined priority rules, means for arranging the name suggestion list so that the name with the highest priority is first in the name suggestion list, and means for setting the name suggestion that is first in the list as the picture file default name.

24. An arrangement according to claim 15, including means for selecting the picture file name from the name suggestion list displayed in the user interface by pointing one or several of the name suggestions.

25. An arrangement according to claim 24, including means for editing the picture file name suggestion in the user interface.

26. An arrangement according to claim 15, wherein said means are software means.

27. A computer program product for naming the picture file recording a picture taken by a mobile station camera, said computer program product including computer-readable instructions embodied in a computer readable medium that upon execution in a computer implement the steps of
searching a given feature associated to the picture from the data available in the mobile station,
adding the searched feature in the picture file name suggestion list and hence for creating said name suggestion list,
displaying the created name suggestion list in the user interface, and
editing the picture file name in the user interface.

28. An arrangement for naming a picture file containing a picture produced by a mobile station camera, said arrangement including a control unit, which control unit is arranged to
search a given feature associated to the picture from a data available in the mobile station,
create a name suggestion on the basis of said searched feature,
add the created name suggestion in the name suggestion list of the picture file and hence create said name suggestion list,
display the created name suggestion list in a user interface, and
receive an edited picture file name from said user interface.

29. An arrangement according to claim 28, wherein said control unit is arranged to search in the mobile station date and time information associated to the moment of shooting, in order to create a name suggestion of the found information and in order to add the name suggestion as a name suggestion in the name suggestion list of the picture file.

30. An arrangement according to claim 28, wherein said control unit is arranged to search in the mobile station a calendar event associated to the moment of shooting at a given accuracy, and to set the possibly found calendar event as a name suggestion in the picture file name suggestion list.

31. An arrangement according to claim 28, wherein said control unit is arranged to search in the mobile station a previously saved picture file name and to add it as a name suggestion in the picture file name suggestion list.

32. An arrangement according to claim 28, wherein said control unit is arranged to search information in the mobile station operational profile and settings, and to create a name suggestion on the basis of the found information, and to add the created name suggestion in the picture file name suggestion list.

33. An arrangement according to claim 28, wherein the arrangement includes an image recognizer arranged to process the picture to be saved and to search recognizable features in the picture, and the control unit is arranged to create a picture file name suggestion according to the features recognized in the picture.

34. An arrangement according to claim 28, wherein the control unit is arranged to enquire location information of the mobile station and to create a picture file name suggestion on the basis of received location information.

35. An arrangement according to claim 28, wherein said user interface is arranged to receive the picture file name suggestion, and the control unit is arranged to search from the mobile station the picture file name suggestion saved in the mobile station.

36. An arrangement according to claim 28, wherein said control unit is arranged to arrange the picture file name suggestions created in the mobile station in an order of priority according to certain predetermined priority rules, to arrange the name suggestion list so that the name with the highest priority is first in the name suggestion list, and to set the name suggestion that is first in the list as the picture file default name.

37. An arrangement according to claim 28, wherein said control unit is arranged to select the picture file name from the name suggestion list displayed in the user interface as a response to a user pointing one or several of the name suggestions.

38. An arrangement according to claim 24, wherein the user interface is arranged to receive changes to the picture file name suggestion.
